(19) United States
(12) Patent Application Publication
(10) Pub. No.: US 2026/0290667 A1
(43) Pub. Date: Sep. 24, 2026

(54) VINYL ESTER RESIN COMPOSITION AND METHOD FOR PRODUCING ELECTRICAL APPLIANCE INSULATOR USING SAME

(71) Applicant: Resonac Corporation, Tokyo (JP)

(72) Inventors: Satoshi KEMMOCHI, Tokyo (JP); Tatsuhito FUKUHARA, Tokyo (JP)

(73) Assignee: Resonac Corporation, Tokyo (JP)

(21) Appl. No.: 19/478,507

(22) PCT Filed: Aug. 28, 2024
(86) PCT No.: PCT/JP2024/030649

§ 371 Date: Oct. 24, 2025

(30) Foreign Application Priority Data
Sep. 1, 2023 (JP) 2023-142401

(51) Int. Cl. H01F 5/06; C08K 3/28; C08K 5/053; C08K 5/08; C08K 5/09; C08K 5/14; C08K 5/1539; C08L 33/06; H01F 41/12

(52) U.S. Cl. CPC H01F 5/06; C08K 3/28; C08K 5/053; C08K 5/08; C08K 5/09; C08K 5/14; C08K 5/1539; C08L 33/06; H01F 41/127

(57) ABSTRACT

A vinyl ester resin composition comprising a vinyl ester resin (A), a reactive diluent (B) containing at least one of a (meth)acrylate having an alicyclic structure and styrene, an unsaturated polyester resin (C), and a metal soap (D), wherein the vinyl ester resin composition is used in combination with a curing agent (E) which initiates a redox reaction in combination with the metal soap (D).

### TECHNICAL FIELD

One embodiment of the present invention relates to a vinyl ester resin composition. More specifically, one embodiment of the present invention relates to a vinyl ester resin composition that can be used favorably for insulation treatment of electrical appliances, including motors such as generators and induction coils, transformers, and electrical appliance coils such as armatures (rotors) and stators. Further, another embodiment of the present invention relates to a method for producing an electrical appliance insulator using the vinyl ester resin composition of the above embodiment.

### BACKGROUND ART

Conventionally, in electrical appliances having a coil, such as rotary machines and transformers, a treatment is typically conducted in which the coil is impregnated with a varnish for the purposes of securing the coil, insulation reinforcement, vibration reduction, and corrosion prevention. The varnishes used in these types of treatments are generally called “coil impregnation varnishes” or an “impregnation varnishes” (hereinafter also abbreviated as simply “varnishes”). These coil impregnation varnishes can be broadly classified into solvent-based varnishes and solventless varnishes, and an appropriate varnish may be selected in accordance with the type of electrical appliance and the treatment method and the like.

The above solvent-based varnishes are prepared, for example, by dissolving an alkyd resin in a solvent sch as naphtha, but suffer from a problem in that a large volume of solvent is scattered during heat curing treatment of the varnish.

On the other hand, the above solventless varnishes are generally prepared by dissolving a resin having unsaturated groups in a reactive diluent. Because a reactive monomer is used as the reactive diluent, solventless varnishes offer the advantage that a large volume of solvent scattering such as that seen with a solvent-based varnish does not occur during heat curing treatment. Further, in recent years, reasons including higher work efficiency (shorter treatment times), resource conservation and anti-corrosion performance have seen an increase in demand for a shift from solvent-based varnishes to solventless varnishes.

Moreover, in recent years, from the viewpoint of carbon neutrality, a reduction in the amount of energy consumed during operations is desirable, and development of varnishes which require little energy consumption to obtain the final cured product are now being sought. Typically, when using an impregnation varnish, a preheating step aimed at achieving varnish impregnation into the gaps between the wound wiring of the coil, and a heat curing step for curing the varnish are provided. In this manner, because heating is required during each step in conducting an insulation treatment of a coil with an impregnation varnish, the energy consumption tends to increase. Accordingly, from the viewpoint of reducing energy consumption, there is a need for a solventless varnish that exhibits excellent impregnation properties, can be cured at low temperature and in a short period of time, and also has superior surface drying properties.

Against this background, much investigation is being conducted into developing solventless varnishes that can be cured at low temperatures and in a short period of time. For example, Patent Document 1 discloses a room temperature-curable unsaturated resin composition containing an unsaturated resin, a polymerizable unsaturated monomer and a shrinkage reducing agent, wherein the unsaturated resin is unsaturated ester that uses dicyclopentadiene as a raw material, the polymerizable unsaturated monomer is styrene, the amount of the polymerizable unsaturated monomer in the resin composition is within a range from 40 to 60% by mass, and the shrinkage reducing agent contains a styrene-acrylic random copolymer having a number average molecular weight of at least 1,000 but less than 15,000.

### PRIOR ART DOCUMENTS

### Patent Document

Patent Document 1: JP 2007-84701 A

### SUMMARY OF THE INVENTION

### Problems to be Solved by the Invention

As outlined above, from the viewpoint of retaining the desired characteristics of the impregnation varnish while reducing energy consumption, there is considerable need for a solventless varnish that exhibits excellent impregnation properties, can be cured at low temperature and in a short period of time, and also has superior surface drying properties. However, achieving satisfactory surface drying properties with conventional resin compositions is difficult, and further improvement would be desirable.

Accordingly, one embodiment of the present invention provides a resin composition that has excellent surface drying properties and can be used favorably in electrical insulation applications such as impregnation varnishes. Further, another embodiment of the present invention provides a method for producing an electrical appliance insulator that uses the resin composition of the above embodiment.

### Means to Solve the Problems

Varnishes containing a vinyl ester resin are known as examples of solventless varnishes. Varnishes containing a vinyl ester resin contain a vinyl ester resin and a crosslinkable monomer, and exhibit excellent levels of various mechanical, electrical and thermal properties, as well as a good balance of workability and economic viability. As a result, these varnishes can be used favorably in many applications, including constriction materials such as fiber-reinforced plastic (FRP) laminates and linings. For these types of reasons, the inventors of the present invention conducted a variety of investigations into the curability and surface drying properties of varnishes containing vinyl ester resins, enabling them to complete the present invention.

In other words, the present invention includes the embodiments described below. However, the present invention is not limited to the following embodiments, and includes a wide variety of embodiments.
<1> A vinyl ester resin composition containing a vinyl ester resin (A), a reactive diluent (B) containing at least one of a (meth)acrylate having an alicyclic structure and styrene, an unsaturated polyester resin (C), and a metal soap (D), wherein the vinyl ester resin composition is used in combination with a curing agent (E) which initiates a redox reaction in combination with the metal soap (D).
<2> The vinyl ester resin composition according to <1>, also containing a curing agent (E) which initiates a redox reaction in combination with the metal soap (D).
<3> The vinyl ester resin composition according to <1> or <2>, wherein
   the composition is a two-liquid composition composed of a first liquid and a second liquid,
   the first liquid contains the vinyl ester resin (A), the reactive diluent (B) containing at least one of a (meth)acrylate having an alicyclic structure and styrene, the unsaturated polyester resin (C), and the metal soap (D), and
   the second liquid contains the curing agent (E) which initiates a redox reaction in combination with the metal soap (D).
<4> The vinyl ester resin composition according to any one of <1> to <3>, wherein the number average molecular weight of the vinyl ester resin (A) is within a range from 1,000 to 10,000.
<5> The vinyl ester resin composition according to any one of <1> to <4>, wherein the reactive diluent (B) contains at least a (meth)acrylate having an alicyclic structure, and the (meth)acrylate having an alicyclic structure includes dicyclopentenyloxyethyl (meth)acrylate.
<6> The vinyl ester resin composition according to any one of <1> to <5>, wherein the unsaturated polyester resin (C) includes an unsaturated polyester resin (C1) having a dicyclopentadiene structure.
<7> The vinyl ester resin composition according to any one of <1> to <6>, wherein the metal soap (D) includes at least one metal soap selected from the group consisting of organic acid cobalt salts and organic acid manganese salts.
<8> The vinyl ester resin composition according to any one of <1> to <7>, wherein the curing agent (E) includes a hydroperoxide.
<9> The vinyl ester resin composition according to any one of <2> to <8>, which is used for imparting insulation properties to a component constituting an electrical appliance.
<10> The vinyl ester resin composition according to any one of <2> to <8>, which is used for conducting an impregnation treatment of an electrical appliance coil.
<11> A method for producing an electrical appliance, the method including:
   applying the vinyl ester resin composition according to any one of <2> to <8> to at least one component that constitutes the electrical appliance to form a coating film, and
   curing the coating film to form a cured coating film.
<12> A method for producing an electrical appliance coil, the method including:
   impregnating the electrical appliance coil with the vinyl ester resin composition according to any one of <2> to <8>, and
   curing the vinyl ester resin composition that has impregnated the electrical appliance coil.

### Effects of the Invention

One embodiment of the present invention is able to provide a vinyl ester resin composition that has excellent surface drying properties and can be used favorably in electrical insulation applications. Further, another embodiment of the present invention is able to provide a method for producing an electrical appliance insulator with reduced energy consumption that uses the resin composition of the above embodiment.

### EMBODIMENTS FOR CARRYING OUT THE INVENTION

Embodiments of the present invention are described below in detail. However, the present invention is not limited to the embodiments described below.

In this description, numerical ranges indicated using the expression “a to b” indicate a range that includes the numerical values before and after the “to” as the minimum value and maximum value respectively. In the case of numerical ranges listed in a stepwise manner in this description, the upper limit value or lower limit value from any particular numerical range may be arbitrarily combined with the upper limit value or lower limit value from another numerical range. Further, the upper limit value or lower limit value from a numerical range disclosed in this description may be used to replace a value shown in an example.

In this description, unless specifically stated otherwise, each component may be composed of a single substance or two or more substances.

In this description, the amount of each component in a resin composition, in the case where a plurality of substances corresponding with that component exist in the resin composition, unless specifically stated otherwise, means the total amount of the plurality of substances that exist in the resin composition.

In this description, the term “(meth)acrylic acid” means at least one of “acrylic acid” and the corresponding “methacrylic acid”. This definition also applies to related expressions such as “(meth)acrylate”.

One embodiment of the present invention relates to a vinyl ester resin composition (hereinafter sometimes abbreviated as “the resin composition”) containing a vinyl ester resin (A), a reactive diluent (B) containing at least one of a (meth)acrylate having an alicyclic structure and styrene, an unsaturated polyester resin (C), and a metal soap (D), wherein the vinyl ester resin composition is used in combination with a curing agent (E) which initiates a redox reaction in combination with the metal soap (D).

The constituent components of the vinyl ester resin composition are described below in further detail.

### [Vinyl Ester Resin (A)]

The vinyl ester resin (A) is a resin obtained by reacting an epoxy compound having two or more epoxy groups, an acid component containing an unsaturated dibasic acid having one or more unsaturated groups, and a modification component if required. A ring-opening reaction between the epoxy groups of the epoxy compound and the carboxyl groups in the acid component forms a compound containing an unsaturated bond (vinyl bond) and an ester linkage within the molecule.

The epoxy compound may be any compound known as a solid epoxy resin or a liquid epoxy resin.

The acid component contains at least the unsaturated dibasic acid mentioned above. Specific examples of the unsaturated dibasic acid include maleic anhydride, maleic acid, and fumaric acid. One of these compounds may be used alone, or a combination of two or more compounds may be used.

In addition to the above unsaturated dibasic acid, the acid component may also contain a saturated acid, or a lower alkyl monoester or diester of the saturated acid or the like.

Examples of the saturated acid include saturated dibasic acids such as phthalic acid, phthalic anhydride, isophthalic acid, terephthalic acid, tetrahydrophthalic anhydride, tetrahydrophthalic acid, hexahydrophthalic anhydride, hexahydrophthalic acid, adipic acid, and sebacic acid.

Examples of the saturated acid lower alkyl monoesters include lower alkyl monoesters of terephthalic acid. Specific examples include monomethyl terephthalate and the like. Further, examples of the saturated acid lower alkyl diesters include lower alkyl diesters of terephthalic acid. Specific examples include dimethyl terephthalate and the like.

In one embodiment, the number average molecular weight (Mn) of the vinyl ester resin (A) may be within a range from 1,000 to 10,000. Mn is preferably within a range from 1,500 to 5,000. When the value of Mn is set to 1,000 or greater, any dramatic deterioration in the curability of the resin composition and the characteristics of the resin cured product can be suppressed. Further, ensuring Mn is 10,000 or less can suppress the viscosity of the resin composition from becoming too high, preventing any significant deterioration in the impregnation workability. Here, Mn refers to a value measured using a gel permeation chromatography method, and is calculated using a calibration curve of standard polystyrenes. This also applies in the description below.

There are no particular limitations on the method used for producing the vinyl ester resin (A), and conventionally known synthesis methods may be applied. For example, the vinyl ester resin (A) can be obtained by conducting a ring-opening reaction using at least an epoxy component containing an epoxy resin and an acid component containing at least one unsaturated dibasic acid. The epoxy component is preferably used in an amount (total amount) within a range from 1 to 2 equivalents per (relative to) 1 equivalent of the total amount of the acid component.

In the production of the vinyl ester resin (A), the reaction temperature used in conducting the synthesis reaction is preferably within a range from 100 to 130° C. Accordingly, the reaction apparatus is preferably formed from glass or stainless steel or the like. Further, the reaction apparatus is preferably fitted with a stirring device, a reflux device for preventing volatilization of the acid component, a heating device for raising the temperature of the reaction system, and a temperature control device for this heating device and the like.

### [Reactive Diluent (B)]

The reactive diluent (B) that constitutes part of the vinyl ester resin composition of an embodiment of the present invention is a compound containing at least one unsaturated group (but excluding the unsaturated polyester resin (C) described below). The reactive diluent (B) is preferably capable of dissolving at least the vinyl ester resin (A) described above and the unsaturated polyester resin (C) described below. The reactive diluent (B) preferably includes at least one of a (meth)acrylate having an alicyclic structure (B1) and styrene (B2).

In one embodiment, from the viewpoint of being able to more easily form a resin composition of low odor, the reactive diluent (B) is preferably a compound having a vapor pressure at 20° C. of not more than 0.1 mmHg. From this viewpoint, in one embodiment, the reactive diluent (B) preferably includes at least a (meth)acrylate having an alicyclic structure (B1).

In one embodiment, the reactive diluent (B) preferably includes the (meth)acrylate having an alicyclic structure (B1) but does not include styrene (B2). In those cases where the (meth)acrylate having an alicyclic structure (B1) is used as the reactive diluent (B), a low-odor resin composition can be more easily provided.

The (meth)acrylate having an alicyclic structure (B1) describes a compound in which the hydrogen atom of the carboxyl group in the (meth)acrylic acid has been substituted with an organic group having an alicyclic structure.

In one embodiment, the above compound may have a structure in which the alicyclic structure is bonded directly to the oxygen atom of the carboxyl group residue (—C(═O)O). In another embodiment, the compound may have a structure in which the alicyclic structure is bonded to the oxygen atom of the carboxyl group residue via a linking group. This linking group may be a divalent organic group, and examples include an alkylene group, an ether linkage, and combinations thereof. Specific examples of the linking group include a methylene group, ethylene group, ether linkage, oxymethylene group, and oxyethylene group.

The organic group having an alicyclic structure may be monocyclic, may contain two or more rings, or may contain two or more condensed rings. Further, the alicyclic structure may contain an unsaturated bond within the ring structure. The alicyclic structure may also contain a bridging structure. The organic group having an alicyclic structure preferably contains two or more rings.

Specific examples of the organic group having an alicyclic structure include a dicyclopentanyl group, dicyclopentenyl group, dicyclopentenyloxyethyl group, and a polyethylene glycol acrylate group.

Specific examples of the (meth)acrylate having an alicyclic structure (B1) include dicyclopentanyl (meth)acrylate, dicyclopentenyloxyethyl (meth)acrylate, phenol ethylene oxide-modified (meth)acrylate, and EO-modified bisphenol A dimethacrylate. Among these, dicyclopentenyloxyethyl (meth)acrylate can be used particularly favorably.

In one embodiment, the reactive diluent (B) may also include a compound (B3) containing at least one unsaturated group but having a different structural unit from the above compounds (B1) and (B2). From the viewpoint of obtaining a low-odor resin composition, the compound (B3) may be a (meth)acrylate other than the above compound (B1) that has a vapor pressure of not more than 0.1 mmHg (20° C.).

Examples include modified (meth)acrylates such as trimethylpropane EO-modified triacrylate and phenol ethylene oxide-modified (meth)acrylate. Further, (meth)acrylates having a hydroxyl group may also be used. Examples include 2-hydroxyethyl methacrylate and (poly)caprolactone monoethoxy (meth)acrylates such as the commercial products PLACCEL FA1, FA2D, FA3, FM1D, FM2D and FM3 available from Daicel Corporation.

Moreover, unsaturated monobasic acids that are the reaction products of a monofunctional (meth)acrylate having a single hydroxyl group in the molecule and a saturated dibasic acid may also be used. One of these compounds above may be used alone, or a combination of two or more such compounds may be used.

In one embodiment, the reactive diluent (B) may be a combination of the above compounds (B1) and (B3), or a combination of the above compounds (B2) and (B3). The compound (B3) preferably includes trimethylpropane EO-modified triacrylate.

The amount of the reactive diluent (B) having one or more unsaturated groups within the molecule is preferably within a range from 50 to 400 parts by mass per 100 parts by mass of the vinyl ester resin (A). When the amount of the reactive diluent (B) is at least 50 parts by mass, the problem wherein the viscosity of the resin composition becomes overly high and the composition adheres thickly to the transformer surface can be suppressed, and the problem of inferior permeability into the interior can also be more easily suppressed. Further, when the amount of the reactive diluent (B) is restricted to not more than 400 parts by mass, cloudiness in the external appearance of the resin composition can be easily suppressed. Furthermore, the problem wherein the varnish viscosity becomes overly low, causing the adhered resin that has permeated into the interior to leak our during heat curing can be more easily suppressed.

The amount of the reactive diluent (B) described above means the total amount of the above compounds (B1) and (B2), and any of the compound (B3) that is used as required.

In a number of embodiments, the amount of the reactive diluent (B), per 100 parts by mass of the vinyl ester resin (A), may be at least 60 parts by mass, at least 70 parts by mass, at least 80 parts by mass, or 90 parts by mass or higher. The amount of the reactive diluent (B) may be not more than 300 parts by mass, not more than 250 parts by mass, not more than 200 parts by mass, or 150 parts by mass or less. In a number of embodiments, the amount of the reactive diluent (B) per 100 parts by mass of the vinyl ester resin (A) is preferably within a range from 90 to 150 parts by mass.

### [Unsaturated Polyester Resin (C)]

The unsaturated polyester resin (C) may be a resin obtained using at least an α,β-unsaturated dibasic acid and an alcohol component having at least one hydroxyl group, by reacting these components together. The unsaturated polyester resin (C) may also be a resin obtained using an acid component containing an α,β-unsaturated dibasic acid, an alcohol component having at least one hydroxyl group, and a modification component that is used as required, by reacting these components together.

In the production of the unsaturated polyester resin (C), at least an unsaturated dibasic acid is used as the acid component. Examples of this unsaturated dibasic acid include maleic anhydride, maleic acid, and fumaric acid. One of these acids may be used alone, or a combination of two or more such acids may be used.

In addition to the above unsaturated dibasic acid, the acid component may also contain a saturated acid, or a lower alkyl monoester or diester of the saturated acid or the like.

Examples of the saturated acid include saturated dibasic acids such as phthalic acid, phthalic anhydride, isophthalic acid, terephthalic acid, tetrahydrophthalic anhydride, tetrahydrophthalic acid, hexahydrophthalic anhydride, hexahydrophthalic acid, adipic acid, and sebacic acid.

Further, examples of the saturated acid lower alkyl monoesters include lower alkyl monoesters of terephthalic acid. Specific examples include monomethyl terephthalate and the like.

Furthermore, examples of the saturated acid lower alkyl diesters include lower alkyl diesters of terephthalic acid. Specific examples include dimethyl terephthalate and the like.

Moreover, edible fatty acids such as soybean oil fatty acids, linseed oil fatty acids, and tall oil fatty acids may also be used in combination with the above compounds. The amount of unsaturated acid preferably represents 50 to 90 equivalent weight % of the total acid component.

On the other hand, examples of the alcohol component include ethylene glycol, propylene glycol, diethylene glycol, dipropylene glycol, 1,3-butanediol, neopentyl glycol, glycerol, trimethylolpropane, and pentaerythritol. One of these compounds may be used alone, or a combination of two or more compounds may be used.

Examples of the modification component that may be used as required include linseed oil, soybean oil, tall oil, dehydrated castor oil, coconut oil, dicyclopentadiene, and cyclopentadiene.

The method used for producing the unsaturated polyester resin (C) used in the present invention may apply conventionally known methods. For example, a condensation reaction may be conducted using only the essential components, namely the α,β-unsaturated dibasic acid and the alcohol having at least one hydroxyl group, or an additional polybasic acid component and/or a polyhydric alcohol component may also be used in the condensation reaction. The production of the unsaturated polyester resin (C) is conducted with the condensation water produced during the condensation reaction being continuously removed from the system. The amount of the total alcohol component is preferably within a range from 1 to 2 equivalents per 1 equivalent of the total acid component.

The method used for removing the condensation water from the reaction system preferably applies a method that relies on natural distillation under a stream of an inert gas or distillation under reduced pressure. In order to accelerate the distillation of the condensation water, solvent such as toluene or xylene may be added to the system as an azeotropic component. Progress of the reaction is generally ascertained by measurement of the amount of the distillation fraction produced by the reaction, measurement of the terminal functional groups, or measurement of the viscosity of the reaction system or the like.

The reaction temperature required for conducting the synthesis reaction is preferably within a range from 150 to 250° C. Accordingly, the reaction apparatus is preferably formed from glass or stainless steel or the like. The reaction apparatus is preferably fitted with a stirring device, a fractional distillation device for preventing distillation of the alcohol component via azeotropic distillation of water and the alcohol component, a heating device for raising the temperature of the reaction system, and a temperature control device for this heating device and the like.

The pressure inside the reaction apparatus may be controlled to ensure progression of the polycondensation reaction during the synthesis. There are no particular limitations on the pressure inside the reaction apparatus, and the reaction proceeds without any problems even at normal pressure. In the case of pressurization, the reaction can be accelerated by increasing the boiling point of the polyhydric alcohol. The reaction is preferably conducted with the pressure inside the reaction apparatus set to a value within a range from normal pressure to 0.1 MPa.

The number average molecular weight (Mn) of the unsaturated polyester resin (C) may be within a range from 1,000 to 10,000. Mn is preferably within a range from 1,500 to 5,000. When the value of Mn is set to 1,000 or greater, any dramatic deterioration in the curability of the resin composition and the characteristics of the resin cured product can be suppressed. Further, ensuring Mn is 10,000 or less can suppress the viscosity of the resin composition from becoming too high, preventing any significant deterioration in the impregnation workability. This Mn value refers to a value measured using a gel permeation chromatography method, and is calculated using a calibration curve of standard polystyrenes. This also applies to Mn values in the description below.

In the vinyl ester resin composition of an embodiment of the present invention, the unsaturated polyester resin (C) includes at least an unsaturated polyester resin having a dicyclopentadiene structure (skeleton) (C1). By using this compound (C1), the surface drying properties can be more easily improved. The unsaturated polyester resin having a dicyclopentadiene structure (C1) can be produced by using an alcohol modified by dicyclopentadiene in the reaction between the unsaturated dibasic acid and the alcohol having at least one hydroxyl group. In one embodiment, the unsaturated polyester resin (C1) may be a compound obtained by combining dicyclopentadiene (100 parts), maleic anhydride (70 parts), diethylene glycol (100 parts) and ethylene glycol (10 parts), and then conducting a condensation reaction under heat. The amounts of the various components are not limited to the values above, and may be adjusted as appropriate.

In one embodiment, the unsaturated polyester resin (C) may also include an unsaturated polyester resin (C2) having a structure different from the unsaturated polyester resin having a dicyclopentadiene structure (C1). The unsaturated polyester resin (C2) is not particularly limited, and may be any unsaturated polyester resin that does not contain a dicyclopentadiene structure.

The amount of the unsaturated polyester resin (C) is preferably within a range from 10 to 80 parts by mass per 100 parts by mass of the vinyl ester resin (A). The amount of the unsaturated polyester resin (C) is more preferably within a range from 15 to 70 parts by mass, even more preferably from 20 to 60 parts by mass, and particularly preferably from 20 to 50 parts by mass.

When the amount of the unsaturated polyester resin (C) is at least 10 parts by mass, the surface drying properties can be more easily improved. Further, when the amount of the unsaturated polyester resin (C) is restricted to not more than 80 parts by mass, the problem of a deterioration in the viscosity and curability causing a worsening of the impregnation workability can be suppressed.

The amount of the unsaturated polyester resin (C) described above means the total amount of the above compound (C1), and any of the compound (C2) that is used as required. In one embodiment, the proportion of the compound (C1) within the total mass of the unsaturated polyester resin (C) is preferably at least 50% by mass, more preferably at least 60% by mass, and even more preferably 70% by mass or greater. In one embodiment, the proportion of the compound (C1) within the total mass of the unsaturated polyester resin (C) is preferably 100% by mass.

### [Metal Soap (D)]

The metal soap (D) may be a metal salt of an organic acid. Examples of the organic acid may include fatty acids such as acetic acid, octylic acid and stearic acid, as well as naphthenic acid. The metal in the metal salt may be Mg, Ca, Zn, Al, V, Cr, Mn, Fe, Co, Ni, Pb, Cu, or Zr or the like. A single metal soap (D) may be used alone, or a combination of two or more metal soaps (D) may be used.

In one embodiment, the metal soap (D) preferably includes one of an organic acid cobalt salt and an organic acid manganese salt. In one embodiment, the metal soap (D) more preferably includes at least an organic acid cobalt salt, and even more preferably also includes an organic acid manganese salt. In a number of embodiments, cobalt octoate and/or manganese octoate can be used favorably. In a number of embodiments, a single organic acid manganese salt is preferably used alone, and among the various options, the use of manganese octoate is preferred.

The amount used of the metal soap (D) may be within a range from 0.01 to 3.0 parts by mass per 100 parts by mass of the combined mass of the vinyl ester resin (A) and the reactive diluent (B). The amount used of the metal soap (D) is preferably within a range from 0.05 to 2.5 parts by mass, and more preferably from 0.07 to 2 parts by mass. At amounts less than 0.01 parts by mass, progression of the redox reaction in combination with the curing agent (E) described below tends to slow, causing a deterioration in curability, whereas addition of an amount exceeding 3.0 parts by mass yields no further promotion of the curability, and there is a possibility that the hue of the obtained cured coating film may darken. In a number of embodiments, the amount used of the metal soap (D) may be at least 0.08 parts by mass, at least 0.09 parts by mass, at least 0.1 parts by mass, at least 0.4 parts by mass, or 0.5 parts by mass or greater, and may be not more than 1.6 parts by mass, not more than 1.5 parts by mass, or 1.0 parts by mass or less.

### [Curing Agent (E)]

The curing agent (E) may be a compound that initiates a redox reaction in combination with the above metal soap (D). Examples of the curing agent (E) include organic peroxides such as percarbonates, alkyl peresters, diacyl peroxides, and hydroperoxides. Specific examples are listed below.

Examples of the percarbonates include methyl ethyl ketone peroxide, acetylacetone peroxide, cumene hydroperoxide, tert-butyl peroxy 3,5,5-trimethylhexanoate, tert-butyl peroxy diisopropyl carbonate, tert-butyl peroxybenzoate, benzoyl peroxide, cumyl hydroperoxide, bis(4-tert-butylcyclohexyl) peroxydicarbonate, di-2-methoxyethyl peroxydicarbonate, di-3-methoxybutyl peroxydicarbonate, di-2-methylhexyl peroxydicarbonate, and diisopropyl peroxydicarbonate.

Examples of the alkyl peresters include 1,1,3,3-tetramethylbutyl peroxyneodecanoate, α-cumene peroxyneodecanoate, tert-butyl peroxyneodecanoate, tert-hexyl peroxyneodecanoate, tert-butyl peroxypivalate, tert-hexyl peroxypivalate, 1,1,3,3-tetramethylbutyl peroxy-di-2-ethylhexanoate, tert-hexylperoxy-2-ethylhexanoate, tert-butyl peroxy-2-ethylhexanoate, tert-butyl peroxyisobutyrate, 2,5-dimethyl-2,5-bis(2-ethylhexanoylperoxy)hexane, and tert-amyl peroxy-2-ethylhexanoate.

Examples of the diacyl peroxides include isobutyroyl peroxide, bis-3,5,5-trimethylhexanoyl peroxide, and lauroyl peroxide.

Examples of the hydroperoxides include cumyl hydroperoxide, p-isopropylcumyl hydroperoxide, t-butyl hydroperoxide (TBH), methyl ethyl ketone hydroperoxide, 1,1,3,3-tetramethylbutyl hydroperoxide, and cyclohexane hydroperoxide.

One of these organic peroxides may be used alone, or a combination of two or more such organic peroxides may be used. In one embodiment, the curing agent (E) preferably includes a hydroperoxide that is capable of initiating a curing reaction at a temperature of 80° C. or lower, and more preferably a temperature of 60° C. or lower. For example, cumyl hydroperoxide can be used favorably.

In a number of embodiments, the curing agent (E) preferably includes lauroyl peroxide and 1,1-bis(t-butylperoxy)cyclohexane, and this type of combination of curing agents is preferred in terms of enabling the permeability and pot life of the resin composition to be easily improved.

The amount used of this curing agent (E) that initiates a redox reaction in combination with the metal soap (D), relative to 1 part by mass of the metal soap (D), may be at least 0.01 parts by mass, at least 0.1 parts by mass, at least 0.5 parts by mass, at least 0.9 parts by mass, or 1 part by mass or greater. Further, the amount used of the curing agent (E) per 1 part by mass of the metal soap (D) may be not more than 20 parts by mass, not more than 15 parts by mass, not more than 10 parts by mass, not more than 5 parts by mass, or 3 parts by mass or less.

In a number of embodiments, the amount used of the curing agent (E) per 1 part by mass of the metal soap (D) may be within a range from 0.01 to 3.0 parts by mass, and is preferably within a range from 0.01 to 2.0 parts by mass, more preferably from 0.1 to 1.5 parts by mass, and even more preferably from 0.2 to 1.0 parts by mass.

When the amount used of the curing agent (E) falls within the above range, the redox reaction is accelerated, and superior curability tends to be more easily obtained. Further, the problem wherein the fixing strength with the obtained cured portion deteriorates tends to be more easily suppressed.

### [Polymerization Inhibitor]

In one embodiment, the vinyl ester resin composition may also contain a polymerization inhibitor if required.

Specific examples of this polymerization inhibitor include p-benzoquinone, hydroquinone, naphthoquinone, p-toluquinone, 2,5-diphenyl-p-benzoquinone, 2,5-diacetoxy-p-benzoquinone, p-tert-butylcatechol, 2,5-di-tert-butylhydroquinone, di-tert-butyl-p-cresol, hydroquinone monomethyl ether, and 2,6-di-tert-butyl-4-methylphenol.

The amount added of the polymerization inhibitor may be determined appropriately in accordance with the curability of the obtained vinyl ester resin composition. For example, the amount added of a polymerization inhibitor (G) is preferably within a range from 0.01 to 5.0 parts by mass, and more preferably from 0.5 to 3 parts by mass, per 100 parts by mass of the vinyl ester resin composition.

### [Other Additives]

Various additives may also be added as required to the vinyl ester resin composition of an embodiment of the present invention, with due consideration of the desired characteristics for the composition. These various additives may be known compounds, and commercially available products may be used.

For example, the addition of one or more additives having an air blocking effect on the cured product surface is preferred. By adding this type of additive, the surface curing (surface drying) time can be shortened. Examples of additives that can be used to shorten the surface curing include paraffin waxes of various melting points, and low volatility agents such as BYK-S740 and BYK-S750 (manufactured by BYK-Chemie Japan K.K.). The amount of wax added, may be within a range from 0.05 to 1 part by mass, and preferably from 0.1 to 0.5 parts by mass, per 100 parts by mass of the vinyl ester resin composition.

The above vinyl ester resin composition according to an embodiment of the present invention contains the vinyl ester resin (A), the reactive diluent (B) containing at least one of a (meth)acrylate having an alicyclic structure and styrene, the unsaturated polyester resin (C), and the metal soap (D), and upon use, the vinyl ester resin composition is used in combination with the curing agent (E) which initiates a redox reaction in combination with the metal soap (D). From this viewpoint, in one embodiment, in addition to the vinyl ester resin (A), the reactive diluent (B), the unsaturated polyester resin (C) and the metal soap (D), the vinyl ester resin composition may also contain the curing agent (E).

Further, in another embodiment, the vinyl ester resin composition may be a two-liquid composition composed of a first liquid and a second liquid, wherein
the first liquid contains the vinyl ester resin (A), the reactive diluent (B) containing at least one of a (meth)acrylate having an alicyclic structure and styrene, the unsaturated polyester resin (C), and the metal soap (D), and
the second liquid contains the curing agent (E) which initiates a redox reaction in combination with the metal soap (D).

The vinyl ester resin composition of an embodiment of the present invention can be cured at low temperature and in a short period of time (for example, within 20 minutes at a temperature of 60° C. or lower), and also has superior surface drying properties. As a result, the composition can be used favorably as a varnish for conducting insulation treatments of electrical appliances typified by transformers and motors.

### <Method for Producing Electrical Appliance>

The vinyl ester resin composition of an embodiment of the present invention described above can be used favorably for imparting insulation properties to (conducting an insulation treatment of) a component constituting an electrical appliance. This insulation treatment may be conducted using known methods. Because the vinyl ester resin composition of an embodiment of the present invention can be cured at low temperature and in a short period of time, and also has superior drying properties, workability can be improved, and a reduction in energy consumption is also possible.

From these types of viewpoints, one embodiment of the present invention can provide a method for producing an electrical appliance that uses the vinyl ester resin composition of an embodiment described above. For example, the present invention can provide a method for producing a coil for an electrical appliance that includes subjecting the electrical appliance coil to an impregnation treatment (insulation treatment) using the vinyl ester resin composition.

In one embodiment, the method for producing an electrical appliance involves applying the vinyl ester resin composition according to an embodiment described above to at least one component that constitutes the electrical appliance to form a coating film, and then curing the coating film to form a cured coating film. Another embodiment is a method for producing a coil for an electrical appliance, and involves impregnating the electrical appliance coil with the vinyl ester resin composition according to an embodiment described above, and then curing the vinyl ester resin composition that has impregnated the electrical appliance coil.

In the production method described above, the application (supply) of the vinyl ester resin composition to the electrical appliance is preferably conducted, for example, using a method in which either the vinyl ester resin composition is dripped onto the electrical appliance, or the electrical appliance is immersed in the vinyl ester resin composition for a period of 2 to 20 minutes. Curing of the vinyl ester resin composition applied (supplied) to the electrical appliance, in the case where the electrical appliance is immersed in the composition, is conducted by removing the electrical appliance from the composition and then conducting heating. The heating during the curing process is preferably conducted under conditions of normal temperature (approximately 25° C.) for 1 to 3 hours, or a temperature of 60° C. for 0.5 hours (or preferably 1 hour). In another method, the electrical appliance such as a coil is subjected to preheating for the purpose of enhancing the impregnation of the resin composition, and the resin composition can then be cured using the residual heat.

### EXAMPLES

The present invention is described below in further detail using a series of examples, but the present invention is not limited to the following examples, and various modifications are possible.

In the following description, unless stated otherwise, “parts” means “parts by mass”.

The number average molecular weight (Mn) values and acid values disclosed below were measured using the methods described below.

### (Method for Measuring Number Average Molecular Weight (Mn))

Number average molecular weight values were measured by gel permeation chromatography (GPC), and were calculated using a calibration curve produced using standard polystyrenes. The calibration curve was approximated as a cubic equation using TSK Standard Polystyrenes (Types A-2500, A-5000, F-1, F-2, F-4, F-10, F-20, F-40) (brand names, manufactured by Tosoh Corporation).

The GPC measurement conditions are shown below.

### (Apparatus)

Pump: L-6200 (manufactured by Hitachi High-Tech Corporation)

Detector: L-3300 RI detector (manufactured by Hitachi High-Tech Corporation)

Column oven: L-655A-52 (manufactured by Hitachi High-Tech Corporation)

Columns: TSK Guardcolumn HHR-L+columns: TSKgel G4000HHR+TSKgel G2000HHR (all product names from Tosoh Corporation)

Column sizes: 6.0×40 mm (guard column), 7.8×300 mm (columns)

### (Measurement Conditions)

Eluent: tetrahydrofuran

Sample concentration: 30 mg/5 mL

Injection volume: 20 μL

Flow rate: 1.00 mL/minute

Measurement temperature: 40° C.

### (Method for Measuring Acid Value)

Acid values were measured using a neutralization titration method based on JIS K0070 such as the method described below. Following accurate weighing of 1 g of the polymer to be measured, 30 g of acetone was added to the polymer to uniformly dissolve the polymer. Subsequently, an appropriate amount of the indicator phenolphthalein was added to the solution, and a titration was conducted using a 0.1 N KOH aqueous solution. The acid value was then calculated from the following formula.

$$Acid value = 0.1 \times Vf \times 5 6.1 / ( Wp \times I / 100 )$$

In the formula, Vf indicates the titer (mL) of the KOH aqueous solution, Wp indicates the mass (g) of the measured resin solution, and I indicates the proportion (% by mass) of the non-volatile fraction in the measured resin solution.

### <Synthesis of Raw Materials>

### (Synthesis Example 1) Synthesis of Vinyl Ester Resin (A)

A 3-liter flask fitted with a thermometer, a nitrogen blow tube, a fractionating column and a stirring device was charged with 100 parts (0.47 mol) of an epoxy resin, 20 parts (0.55 mol) of methacrylic acid, 0.03 parts (0.07 mol) of maleic anhydride, 0.004 parts (0.01 mol) of ammonium tetrachloride and 0.0002 parts (0.002 mol) of hydroquinone, and a thermal condensation reaction was conducted at 110° C. over a period of 6 hours. This yielded a vinyl ester resin (A-1) having a weight average molecular weight of 3,000 and an acid value of 18.0 mgKOH/g.

### (Synthesis Example 2) Synthesis of Unsaturated Polyester Resin (C1) Having Dicyclopentadiene Structure

A 3-liter flask fitted with a thermometer, a nitrogen blow tube, a fractionating column and a stirring device was charged with 100 parts of dicyclopentadiene, 70 parts of maleic anhydride, 100 parts of diethylene glycol and 10 parts of ethylene glycol, and the mixture was heated at 210° C. across a period of 8 hours to effect a condensation reaction. This yielded an unsaturated polyester resin (C1-1) having a weight average molecular weight of 2,890 and an acid value of 28.5 mgKOH/g.

### <I-1> Preparation of Vinyl Ester Resin Compositions

### Example 1

To 100 parts of the vinyl ester resin (A-1) produced in the above Synthesis Example 1 were added:
100 parts of dicyclopentenyloxyethyl (meth)acrylate (vapor pressure at 20° C.: 0.15 mmHg) as the component (B1),
20 parts of trimethylpropane EO-modified triacrylate (M3130 manufactured by Kyoeisha Chemical Co., Ltd.) as the component (B3),
50 parts of the unsaturated polyester resin (C1-1) having a dicyclopentadiene structure produced in the above Synthesis Example 2 as the component (C), and
1.0 parts of manganese octoate as the component (D),
thus obtaining a vinyl ester resin composition 1.

In a separate preparation, 2.0 parts of cobalt octoate (Co-Octoate 6%, manufactured by DIC Corporation) as another component (D) and 3.0 parts of cumyl hydroperoxide (PERCUMYL H-80, manufactured by NOF Corporation) as the component (E) were prepared. These two components were added to the vinyl ester resin composition 1 prepared above and mixed, yielding a vinyl ester resin composition 1-1.

### Example 2

To 100 parts of the vinyl ester resin (A-1) produced in the above Synthesis Example 1 were added:
100 parts of dicyclopentenyloxyethyl (meth)acrylate (vapor pressure at 20° C.: 0.15 mmHg) as the component (B1), and 20 parts of trimethylpropane EO-modified triacrylate (M3130 manufactured by Kyoeisha Chemical Co., Ltd.) as the component (B3),
50 parts of the unsaturated polyester resin (C1-1) having a dicyclopentadiene structure produced in the above Synthesis Example 2 as the component (C), and
1.0 parts of manganese octoate and 0.1 parts of cobalt octoate (Co-Octoate 6%, manufactured by DIC Corporation) as the component (D),
thus obtaining a vinyl ester resin composition 2.

In a separate preparation, 3.0 parts of cumyl hydroperoxide (PERCUMYL H-80, manufactured by NOF Corporation) was prepared as the component (E). This component (E) was added to the vinyl ester resin composition 2 prepared above and mixed, yielding a vinyl ester resin composition 2-1.

### Example 3

To 100 parts of the vinyl ester resin (A-1) produced in the above Synthesis Example 1 were added:
100 parts of dicyclopentenyloxyethyl (meth)acrylate (vapor pressure at 20° C.: 0.15 mmHg) as the component (B1), and 20 parts of trimethylpropane EO-modified triacrylate (M3130 manufactured by Kyoeisha Chemical Co., Ltd.) as the component (B3),
50 parts of the unsaturated polyester resin (C1-1) having a dicyclopentadiene structure produced in the above Synthesis Example 2 as the component (C), and
1.0 parts of manganese octoate as the component (D),
thus obtaining a vinyl ester resin composition 3.

In a separate preparation, 3.0 parts of cumyl hydroperoxide (PERCUMYL H-80, manufactured by NOF Corporation) was prepared as the component (E). This component (E) was added to the vinyl ester resin composition 3 prepared above and mixed, yielding a vinyl ester resin composition 3-1.

### Example 4

To 100 parts of the vinyl ester resin (A-1) produced in the above Synthesis Example 1 were added:
100 parts of dicyclopentenyloxyethyl (meth)acrylate (vapor pressure at 20° C.: 0.15 mmHg) as the component (B1), and 20 parts of trimethylpropane EO-modified triacrylate (M3130 manufactured by Kyoeisha Chemical Co., Ltd.) as the component (B3),
20 parts of the unsaturated polyester resin (C1-1) having a dicyclopentadiene structure produced in the above Synthesis Example 2 as the component (C), and
1.0 parts of manganese octoate and 0.1 parts of cobalt octoate (Co-Octoate 6%, manufactured by DIC Corporation) as the component (D),
thus obtaining a vinyl ester resin composition 4.

In a separate preparation, 3.0 parts of cumyl hydroperoxide (PERCUMYL H-80, manufactured by NOF Corporation) was prepared as the component (E). This component (E) was added to the vinyl ester resin composition 4 prepared above and mixed, yielding a vinyl ester resin composition 4-1.

### Example 5

To 100 parts of the vinyl ester resin (A-1) produced in the above Synthesis Example 1 were added:
100 parts of dicyclopentenyloxyethyl (meth)acrylate (vapor pressure at 20° C.: 0.15 mmHg) as the component (B1), and 20 parts of trimethylpropane EO-modified triacrylate (M3130 manufactured by Kyoeisha Chemical Co., Ltd.) as the component (B3),
50 parts of the unsaturated polyester resin (C1-1) having a dicyclopentadiene structure produced in the above Synthesis Example 2 as the component (C), and
3.0 parts of manganese octoate and 0.1 parts of cobalt octoate (Co-Octoate 6%, manufactured by DIC Corporation) as the component (D),
thus obtaining a vinyl ester resin composition 5.

In a separate preparation, 3.0 parts of cumyl hydroperoxide (PERCUMYL H-80, manufactured by NOF Corporation) was prepared as the component (E). This component (E) was added to the vinyl ester resin composition 5 prepared above and mixed, yielding a vinyl ester resin composition 5-1.

### Example 6

To 100 parts of the vinyl ester resin (A-1) produced in the above Synthesis Example 1 were added:
100 parts of styrene (vapor pressure at 20° C.: 0.15 mmHg) as the component (B2), and 20 parts of trimethylpropane EO-modified triacrylate (M3130 manufactured by Kyoeisha Chemical Co., Ltd.) as the component (B3),
50 parts of the unsaturated polyester resin (C1-1) having a dicyclopentadiene structure produced in the above Synthesis Example 2 as the component (C), and
1.0 parts of manganese octoate as the component (D),
thus obtaining a vinyl ester resin composition 6.

In a separate preparation, 3.0 parts of cumyl hydroperoxide (PERCUMYL H-80, manufactured by NOF Corporation) was prepared as the component (E). This component (E) was added to the vinyl ester resin composition 6 prepared above and mixed, yielding a vinyl ester resin composition 6-1.

### Comparative Example 1

With the exception of not using the component (C) in the preparation of the vinyl ester resin composition 2 described above in Example 2, exactly the same method as Example 2 was used to prepare a vinyl ester resin composition 7 and then obtain a vinyl ester resin composition 7-1.

### Comparative Example 2

With the exception of not using the component (D) (the metal soap), a vinyl ester resin composition 8 was prepared in the same manner as the preparation of the vinyl ester resin composition 2 described above in Example 2, and with the exception of altering the amount added of the component (E) (the curing agent) to 1.5 parts, the same method as Example 2 was then used to obtain a vinyl ester resin composition 8-1.

### <1-2> Evaluations of Vinyl Ester Resin Compositions

The vinyl ester resin compositions 1-1 to 8-1 prepared in Examples 1 to 6 and Comparative Examples 1 and 2 were each evaluated for gelling time, surface drying properties and pot life using the methods described below. The results of these evaluations are shown in Table 1.

### [1] Gelling Time

Using each of the vinyl ester resin compositions 1-1 to 8-1 prepared in the examples and comparative examples, the 60° C. gelling time was measured by the test tube method in accordance with the method prescribed in JIS C2105.

### [2] Surface Drying Properties

Using each of the vinyl ester resin compositions 1-1 to 8-1 prepared in the examples and comparative examples, 1.5 g of the vinyl ester resin composition was placed in a metal laboratory dish of diameter 60 mm. Subsequently, the metal laboratory dish was left to stand in a 60° C. thermostatic chamber, and the time required for the surface to lose stickiness was measured.

### [3] Pot Life

Using each of the vinyl ester resin compositions 1-1 to 8-1 prepared in the examples and comparative examples, 50 g of the vinyl ester resin composition was placed in a 100 mL plastic cup. Subsequently, the plastic cup was left to stand in a 25° C. water bath, and the time required for gelling to occur was measured.

TABLE 1

| | | | | | | | | Comparative | Comparative |
|---|---|---|---|---|---|---|---|---|---|
| | Vinyl ester | Example 1 | Example 2 | Example 3 | Example 4 | Example 5 | Example 6 | Example 1 | Example 2 |
| | resin composition | 1-1 | 2-1 | 3-1 | 4-1 | 5-1 | 6-1 | 7-1 | 8-1 |
| (A) | Vinyl ester | 100 | 100 | 100 | 100 | 100 | 100 | 100 | 100 |
| | resin (A-1) | | | | | | | | |
| (B) | Dicyclopentenyloxyethyl | 100 | 100 | 100 | 100 | 100 | 0 | 100 | 100 |
| | (meth)acrylate (B1) | | | | | | | | |
| | Styrene (B2) | | | | | | 100 | | |
| | Trimethylpropane | 20 | 20 | 20 | 20 | 20 | 20 | 20 | 20 |
| | EO-modified | | | | | | | | |
| | triacrylate (B3) | | | | | | | | |
| (C) | Unsaturated polyester | 50 | 50 | 50 | 20 | 50 | 50 | 0 | 50 |
| | resin having | | | | | | | | |
| | dicyclopentadiene | | | | | | | | |
| | structure (C1) | | | | | | | | |
| (D) | Manganese octoate | 1.0 | 1.0 | 1.0 | 1.0 | 3.0 | 1.0 | 1.0 | 0.0 |
| | Cobalt octoate | 2.0 | 0.1 | 0.0 | 0.1 | 0.1 | 0.0 | 0.1 | 0.0 |
| (E) | Cumyl hydroperoxide | 3.0 | 3.0 | 3.0 | 3.0 | 3.0 | 3.0 | 3.0 | 1.5 |
| Evaluations | Gelling time (60° | 4.33 | 6.33 | 20 | 6.3 | 10 | 20 | 3.5 | — |
| | C., minutes) | | | | | | | | |
| | Surface drying | 20 | 30 | 120 | 120 | 60 | 60 | >120 | >120 |
| | properties | | | | | | | | |
| | (60° C., minutes) | | | | | | | | |
| | Pot life (25° | 30 | 150 | 360 | 360 | 360 | 360 | 50 | — |
| | C., minutes) | | | | | | | | |

As is evident from Table 1, the surface drying properties of the resin compositions of embodiments of the present invention (Examples 1 to 6), which contained all of the components (A) to (E), exhibited drying times for the surface to lose stickiness of not more than 120 minutes at 60° C. Further, the gelling time and the pot life were also within ranges that yielded no practical problems.

In contrast, evaluation of the surface drying properties for both Comparative Example 1 and Comparative Example 2 revealed surface stickiness even after 120 minutes at 60° C., a clearly inferior result compared with the Examples. Accordingly, in Comparative Example 2, evaluations of the gelling time and the pot life were not conducted. Comparative Example 1 was a resin composition lacking the component (C), whereas Comparative Example 2 was a resin composition lacking the component (D). Accordingly, it was evident that by using a resin composition having all of the specific components (A) to (E) of the present invention, improvements in the surface drying properties could be achieved.

### <II-1> Preparation of Vinyl Ester Resin Compositions

### Example 7

To 100 parts of the vinyl ester resin (A-1) produced in the above Synthesis Example 1 were added:
100 parts of dicyclopentenyloxyethyl (meth)acrylate (vapor pressure at 20° C.: 0.15 mmHg) as the component (B1),
20 parts of trimethylpropane EO-modified triacrylate (M3130 manufactured by Kyoeisha Chemical Co., Ltd.) as the component (B3),
20 parts of the unsaturated polyester resin (C1-1) having a dicyclopentadiene structure produced in the above Synthesis Example 2 as the component (C), and
0.2 parts of manganese octoate as the component (D),
thus obtaining a vinyl ester resin composition 9.

In a separate preparation, 3.0 parts of cumyl hydroperoxide (PERCUMYL H-80, manufactured by NOF Corporation) was prepared as the component (E). This component (E) were added to the vinyl ester resin composition 9 prepared above and mixed, yielding a vinyl ester resin composition 9-1.

### Example 8

Using the blend ratio shown in Table 2, a vinyl ester resin composition 10-1 was obtained in the same manner as the preparation of the vinyl ester resin composition 9-1 described in Example 8.

### Example 9

Using the blend ratio shown in Table 2, a vinyl ester resin composition 11-1 was obtained in the same manner as the preparation of the vinyl ester resin composition 9-1 described in Example 8. The compounds used as the component (E) instead of the cumyl hydroperoxide were as described below.
Lauroyl peroxide: product name “Laurox” manufactured by Kayaku Nouryon Corporation
1,1-bis(t-butylperoxy)cyclohexane: product name “Trigonox 22-70E” manufactured by Kayaku Nouryon Corporation

### Example 10

Using the blend ratio shown in Table 2, a vinyl ester resin composition 12-1 was obtained in the same manner as the preparation of the vinyl ester resin composition 9-1 described in Example 8. For the cobalt octoate, 0.05 parts of cobalt octoate (Co-Octoate 6%, manufactured by DIC Corporation) was used.

### <II-2> Evaluations of Vinyl Ester Resin Compositions

The vinyl ester resin compositions 9-1 to 12-1 prepared in Examples 7 to 10 were each evaluated for gelling time, surface drying properties, permeability and pot life using the methods described below. The results of these evaluations are shown in Table 2.

### [1] Gelling Time

Using each of the vinyl ester resin compositions 9-1 to 13-1 prepared in Examples 7 to 11, the 100° C. and 80° C. gelling times were measured by the test tube method in accordance with the method prescribed in JIS C2105 (2019).

From the viewpoint of achieving a practical level, the gelling time under heating conditions of 100° C. is preferably not more than 20 minutes. Under heating conditions of 80° C., the gelling time is preferably not more than 40 minutes.

### [2] Surface Drying Properties

Using each of the vinyl ester resin compositions 9-1 to 13-1 prepared in Examples 7 to 10 and Comparative Example 3, 1.5 g of the vinyl ester resin composition was placed in a metal laboratory dish of diameter 60 mm. Subsequently, the metal laboratory dish was left to stand in a 80° C. thermostatic chamber and evaluated every 10 minutes by finger touch, and the time required for the surface to lose stickiness was measured.

From the viewpoint of achieving a practical level, the surface drying time under heating conditions of 80° C. is preferably not more than 40 minutes.

### [3] Permeability

A heat-resistant tube of diameter 4 mm was cut to a length of 220 mm, and an enamel wire that had been cut to a length of 200 mm was inserted into the tube (hereinafter, this structure is referred to as the “permeability test piece”).

Using each of the vinyl ester resin compositions 9-1 to 13-1 prepared in Examples 7 to 10 and Comparative Example 3, the permeability test piece was preheated uniformly to 100° C., 0.5 g of the resin composition was inserted from the top of the tube, and the test piece was then left to stand in a horizontal orientation. Heating was conducted at 100° C. for 20 minutes, and the distance the varnish had permeated was measured visually.

From the viewpoint of achieving a practical level, the permeation distance under heating conditions of 100° C. is preferably at least 130 mm.

### [4] Pot Life

Using each of the vinyl ester resin compositions 9-1 to 13-1 prepared in Examples 7 to 10 and Comparative Example 3, the resin composition was used to fill a clean test tube with outer dimensions of 18 mm to a height of 70 mm, and the top of the test tube was then sealed with aluminum foil. The test tube was placed in a thermostatic chamber set to 40° C., and the time required for gelling to occur was measured. Gelling was deemed to have occurred when the sample had changed from the start of the test to either an agar-like state or a cured state.

From the viewpoint of achieving a practical level, the pot life under heating conditions of 40° C. is preferably at least one hour, and more preferably 4 hours or longer.

TABLE 2

| | | Example 7 | Example 8 | Example 9 | Example 10 |
|---|---|---|---|---|---|
| | Vinyl ester resin composition | 9-1 | 10-1 | 11-1 | 12-1 |
| (A) | Vinyl ester resin (A-1) | 100 | 100 | 100 | 100 |
| (B) | Dicyclopentenyloxyethyl (meth)acrylate (B1) | 100 | 100 | 100 | 100 |
| | Trimethylpropane EO-modified triacrylate (B3) | 20 | 20 | 20 | 20 |
| (C) | Unsaturated polyester resin having | 20 | 50 | 20 | 50 |
| | dicyclopentadiene structure (C1) | | | | |
| (D) | Manganese octoate | 0.2 | 0.2 | 2.0 | 1.0 |
| | Cobalt octoate | 0.0 | 0.0 | 0.0 | 0.05 |
| (E) | Cumyl hydroperoxide | 3.0 | 3.0 | 0.0 | 3.0 |
| | Lauroyl peroxide | 0.0 | 0.0 | 1.5 | 0.0 |
| | 1,1-bis(t-butylperoxy)cyclohexane | 0.0 | 0.0 | 1.5 | 0.0 |
| Evaluations | Gelling time (100° C., minutes) | 5.1 | 5.7 | 7.1 | 3.0 |
| | Gelling time (80° C., minutes) | 10.8 | 12.3 | 35 | 7.0 |
| | Surface drying properties (80° C., minutes) | 40 | 30 | 40 | 20 |
| | Permeability (80° C., mm) | 150 | 145 | 190 | 55 |
| | Pot life (40° C., minutes) | 4 | 4 | 24 | 1 |

As is evident from the results in Table 2, the vinyl ester resin compositions 9-1 to 12-1 were each able to exhibit practically applicable surface drying properties. Although not shown in Table 2, when the surface drying properties of the vinyl ester resin compositions 9-1 to 12-1 were evaluated under drying conditions of 60° C., it was confirmed that each composition exhibited a practically applicable level of surface drying properties (namely, a drying time of not more than 120 minutes).

Further, the resin compositions 9-1 to 12-1 were also able to realize practically applicable levels for the gelling time, surface drying properties, permeability and pot life. Among the compositions, it was evident that the vinyl ester resin composition 11-1 of Example 9, which used a combination of lauroyl peroxide and 1,1-bis(t-butylperoxy) cyclohexane as the curing agent (E), tended to enable ready improvement in the permeability and the pot life.

1. A vinyl ester resin composition comprising a vinyl ester resin (A), a reactive diluent (B) containing at least one of a (meth)acrylate having an alicyclic structure and styrene, an unsaturated polyester resin (C), and a metal soap (D), wherein the vinyl ester resin composition is used in combination with a curing agent (E) which initiates a redox reaction in combination with the metal soap (D).

2. The vinyl ester resin composition according to claim 1, further comprising a curing agent (E) which initiates a redox reaction in combination with the metal soap (D).

3. The vinyl ester resin composition according to claim 2, wherein
the composition is a two-liquid composition composed of a first liquid and a second liquid,
the first liquid comprises the vinyl ester resin (A), the reactive diluent (B) containing at least one of a (meth)acrylate having an alicyclic structure and styrene, the unsaturated polyester resin (C), and the metal soap (D), and
the second liquid comprises the curing agent (E) which initiates a redox reaction in combination with the metal soap (D).

4. The vinyl ester resin composition according to claim 1 wherein a number average molecular weight of the vinyl ester resin (A) is within a range from 1,000 to 10,000.

5. The vinyl ester resin composition according to claim 1, wherein the reactive diluent (B) contains at least a (meth)acrylate having an alicyclic structure, and the (meth)acrylate having an alicyclic structure includes dicyclopentenyloxyethyl (meth)acrylate.

6. The vinyl ester resin composition according to claim 1, wherein the unsaturated polyester resin (C) includes an unsaturated polyester resin (C1) having a dicyclopentadiene structure.

7. The vinyl ester resin composition according to claim 1, wherein the metal soap (D) includes at least one metal soap selected from the group consisting of organic acid cobalt salts and organic acid manganese salts.

8. The vinyl ester resin composition according to claim 1, wherein the curing agent (E) includes a hydroperoxide.

9. The vinyl ester resin composition according to claim 2, which is used for imparting insulation properties to a component constituting an electrical appliance.

10. The vinyl ester resin composition according to claim 2, which is used for conducting an impregnation treatment of an electrical appliance coil.

11. A method for producing an electrical appliance, the method comprising:
applying the vinyl ester resin composition according to claim 2 to at least one component constituting the electrical appliance to form a coating film, and
curing the coating film to form a cured coating film.

12. A method for producing an electrical appliance coil, the method comprising:
impregnating the electrical appliance coil with the vinyl ester resin composition according to claim 2, and
curing the vinyl ester resin composition that has impregnated the electrical appliance coil.
